(19) United States
(12) Patent Application Publication
(10) Pub. No.: US 2015/0062501 A1
(43) Pub. Date: Mar. 5, 2015

(54) ADHESIVE COMPOSITION AND POLARIZING PLATE COMPRISING THE SAME

(71) Applicant: DONGWOO FINE-CHEM CO., LTD., Iksan-si (KR)

(72) Inventors: Sungho BAEK, Pyeongtaek-si (KR); Jiyeon WON, Seoul (KR)

(73) Assignee: DONGWOO FINE-CHEM CO., LTD., Iksan-si, (KR)

(21) Appl. No.: 14/471,014

(22) Filed: Aug. 28, 2014

(30) Foreign Application Priority Data
Aug. 30, 2013 (KR) 10-2013-0103655

(51) Int. Cl. C08K 5/548; C09J 133/08; G02F 1/1335; C08K 5/5455

(52) U.S. Cl. CPC C08K 5/548; C08K 5/5455; C09J 133/08; G02F 1/133528; G02F 2202/28
USPC 349/96; 556/429; 556/419; 525/329.8; 525/329.9

(57) ABSTRACT

The present invention provides an adhesive composition comprising a silane coupling agent having a solubility parameter of 10.2 to 13.0 (Cal/cm³)^{0.5}, a polarizing plate and a liquid crystal display device comprising the adhesive composition. The adhesive composition according to the present invention has high adhesive strength and excellent heat resistance and heat and moisture resistance.

### TECHNICAL FIELD

The present invention relates to an adhesive composition and a polarizing plate comprising the same. Particularly, the present invention provides an adhesive composition which has high adhesive strength and excellent adhesive durability under harsh conditions (high temperature or high temperature and humidity), a polarizing plate and a liquid crystal display device comprising the adhesive composition.

### BACKGROUND ART

A liquid crystal display device (LCD) has a liquid crystal panel including a liquid crystal cell and polarizing plates laminated on both sides of the liquid crystal cell through adhesive layers.

The adhesive used to attach the polarizing plates to the liquid crystal cell should simultaneously satisfy adhesion with a substrate, light leakage prevention, durability such as heat resistance and heat and moisture resistance, and adhesive strength. However, since the characteristics of the adhesive for achieving the durability and adhesive strength conflict with each other, both physical properties could not have been completely satisfied.

In order to solve the above problem, a technique adding a silane coupling agent to the adhesive was proposed. Japanese Patent Application Publication No. (Hei)8-104855 discloses an adhesive composition comprising an acrylic polymer and a silane compound of formula (I) having β-ketoester and alkoxy groups, which can attach a polarizing plate to a substrate with good adhesive strength and, if necessary, separate the polarizing plate from the substrate without remaining the adhesive or damaging the substrate.

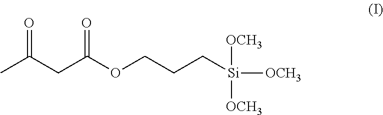 [SMILES: CO[Si](CCCOC(=O)CC(C)=O)(OC)OC]

However, the above compound lowers initial adhesive strength and deteriorates adhesive durability under harsh conditions (high temperature or high temperature and humidity).

### DISCLOSURE

### Technical Problem

It is an object of the present invention to provide an adhesive composition which has high adhesive strength and excellent adhesive durability under harsh conditions (high temperature or high temperature and humidity).

It is another object of the present invention to provide a polarizing plate including an adhesive layer comprising the adhesive composition.

It is still another object of the present invention to provide a liquid crystal display device having the polarizing plate on at least one side of a liquid crystal cell.

### Technical Solution

In accordance with one aspect of the present invention, there is provided an adhesive composition comprising a silane coupling agent having a solubility parameter of 10.2 to 13.0 (Cal/cm³)^{0.5}.

In accordance with another aspect of the present invention, there is provided a polarizing plate including an adhesive layer comprising the adhesive composition.

In accordance with still another aspect of the present invention, there is provided a liquid crystal display device having the polarizing plate on at least one side of a liquid crystal cell.

### Advantageous Effects

The adhesive composition of the present invention has high adhesive strength and excellent adhesive durability under harsh conditions (high temperature or high temperature and humidity). Accordingly, the adhesive composition can be effectively used to attach a polarizing plate to a liquid crystal cell.

### Best Mode

The present invention is, hereinafter, described in more detail.

One embodiment of the present invention relates to an adhesive composition comprising a silane coupling agent having a solubility parameter of 10.2 to 13.0 (Cal/cm³)^{0.5}.

In the present invention, the solubility parameter is an indication of interaction, that is miscibility, between constituents of a composition, and can be calculated according to a method known in the art using a chemical simulator Materials Studio 6.1 [see: J. Phys. Chem. B 2011, 115, 2014-2023].

When the solubility parameter of the silane coupling agent is less than 10.2 (Cal/cm³)^{0.5}, the adhesive durability can be deteriorated by bleeding-out of the silane coupling agent. When the solubility parameter of the silane coupling agent is more than 13.0 (Cal/cm³)^{0.5}, the re-workability can be deteriorated.

In one embodiment of the present invention, the adhesive composition can comprise an acrylic copolymer, a cross-linking agent and a silane coupling agent having a solubility parameter of 10.2 to 13.0 (Cal/cm³)^{0.5}.

In one embodiment of the present invention, the acrylic copolymer is an adhesive resin, which may be a copolymer of an (meth)acrylate monomer having a C₁₋₁₂ alkyl group and a monomer having a cross-linkable functional group. As used herein, the term ‘(meth)acrylate’ refers to acrylate and methacrylate.

By way of examples, the (meth)acrylate monomer having a C₁₋₁₂ alkyl group may include n-butyl (meth)acrylate, 2-butyl (meth)acrylate, t-butyl (meth)acrylate, 2-ethylhexyl (meth)acrylate, 2-ethylbutyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, n-nonyl (meth)acrylate, isononyl (meth)acrylate, decyl (meth)acrylate, lauryl (meth)acrylate, etc. These monomers may be used alone or in combination of two or more. Among them, n-butyl acrylate, 2-ethylhexyl acrylate, and a mixture thereof are preferred.

The (meth)acrylate monomer having a C₁₋₁₂ alkyl group may be preferably contained in an amount of 80 to 99 wt %, more preferably 90 to 95 wt %, based on 100 wt % of the total monomers used for the preparation of the acrylic copolymer. When the amount of the (meth)acrylate monomer having a C₁₋₁₂ alkyl group is less than 80 wt %, the adhesive strength can be insufficient. When the amount of the (meth)acrylate monomer having a C₁₋₁₂ alkyl group is more than 99 wt %, the cohesive strength can be lowered.

The monomer having a cross-linkable functional group is used to give cohesive strength and adhesive strength through chemical bonding with a cross-linking agent described below, and may include a monomer having a hydroxyl group, a monomer having a carboxyl group, a monomer having an amide group, a monomer having a tertiary amine group, etc. These monomers may be used alone or in combination of two or more.

Examples of the monomer having a hydroxyl group may include 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 2-hydroxyethyleneglycol (meth)acrylate, 2-hydroxypropyleneglycol (meth)acrylate, hydroxyalkyleneglycol (meth)acrylate having a C₂₋₄ alkylene group, etc. Among them, 2-hydroxyethyl (meth)acrylate is preferred.

Examples of the monomer having a carboxyl group may include monobasic acids such as (meth)acrylic acid and crotonic acid; dibasic acids such as maleic acid, itaconic acid and fumaric acid, and monoalkylesters thereof; 3-(meth)acryloylpropionic acid; succinic anhydride ring-opening adducts of 2-hydroxyalkyl (meth)acrylate having a C₂₋₃ alkyl group, succinic anhydride ring-opening adducts of hydroxyalkyleneglycol (meth)acrylate having a C₂₋₄ alkylene group, compounds obtained by ring-opening addition of succinic anhydride to carprolactone adduct of 2-hydroxyalkyl (meth)acrylate having a C₂₋₃ alkyl group, etc. Among them, (meth)acrylic acid is preferred.

Examples of the monomer having an amide group may include (meth)acrylamide, N-isopropylacrylamide, N-tert-butylacrylamide, etc. Among them, (meth)acrylamide is preferred.

Examples of the monomer having a tertiary amine group may include N,N-(dimethylamino)ethyl(meth)acrylate, N,N-(diethylamino)ethyl(meth)acrylate, N,N-(dimethylamino)propyl(meth)acrylate, etc.

The monomer having a cross-linkable functional group may be preferably contained in an amount of 1 to 20 wt %, more preferably 1 to 10 wt %, based on 100 wt % of the total monomers used for the preparation of the acrylic copolymer. When the amount of the monomer having a cross-linkable functional group is less than 1 wt %, the cohesive strength can be lowered. When the amount of the monomer having a cross-linkable functional group is more than 20 wt %, the adhesive strength can be deteriorated.

In addition to the above monomers, other monomers may be further contained in a range not to degrade the adhesive strength, for example 10 wt % or less, preferably 5 wt % or less.

The copolymer can be prepared, without limitation, using bulk polymerization, solution polymerization, emulsion polymerization or suspension polymerization, etc. which are conventionally known in the art. Among them, the solution polymerization is preferred. Further, a solvent, a polymerization initiator, a chain transfer agent for controlling the molecular weight, etc. which are conventionally known in the art can be used for the polymerization.

The acrylic copolymer may have a polystyrene-converted weight average molecular weight of 50,000 to 2,000,000, preferably 1,000,000 to 2,000,000, as measured by gel permeation chromatography (GPC).

In one embodiment of the present invention, the cross-linking agent is used to enhance the cohesive strength of the adhesive by cross-linkage the copolymer. By way of examples, the cross-linking agent may include, without limitation, isocyanate compounds, epoxy compounds, etc. These compounds may be used alone or in combination of two or more.

Examples of the isocyanate compounds may include diisocyanate compounds such as tolylene diisocyanate, xylene diisocyanate, 2,4-diphenylmethane diisocyanate, 4,4-diphenylmethane diisocyanate, hexamethylene diisocyanate, isophorone diisocyanate, tetramethylxylene diisocyanate, and naphthalene diisocyanate; multifunctional isocyanate compounds having three functional groups such as adducts obtained by reacting 1 mol of polyhydric alcohol compounds such as trimethylolpropane with 3 mol of diisocyanate compounds, isocyanurates obtained by self-condensation of 3 mol of diisocyanate compounds, biurets obtained by condensation of diisocyanate ureas prepared from 2 mol of diisocyanate compounds with 1 mol of diisocyanate compound, triphenylmethane triisocyanate, and methylenebistriisocyanate.

Examples of the epoxy compounds may include ethyleneglycol diglycidyl ether, diethyleneglycol diglycidyl ether, polyethyleneglycol diglycidyl ether, propyleneglycol diglycidyl ether, tripropyleneglycol diglycidyl ether, polypropyleneglycol diglycidyl ether, neopentylglycol diglycidyl ether, 1,6-hexanediol diglycidyl ether, polytetramethyleneglycol diglycidyl ether, glycerol diglycidyl ether, glycerol triglycidyl ether, diglycerol polyglycidyl ether, polyglycerol polyglycidyl ether, resorcin diglycidyl ether, 2,2-dibromoneopentylglycol diglycidyl ether, trimethylolpropane triglycidyl ether, pentaerythritol polyglycidyl ether, sorbitol polyglycidyl ether, adipic acid diglycidyl ester, phthalic acid diglycidyl ester, tris(glycidyl)isocyanurate, tris(glycidoxyethyl)isocyanurate, 1,3-bis (N,N-glycidylaminomethyl)cyclohexane, N,N,N′,N′-tetraglycidyl-m-xylylenediamine, etc.

In addition to the isocyanate compounds and epoxy compounds, melamine compounds may be further used alone or in combination of two or more.

Examples of the melamine compounds may include hexamethylolmelamine, hexamethoxymethylmelamine, hexabutoxymethylmelamine, etc.

The cross-linking agent may be preferably contained in an amount of 0.1 to 15 parts by weight, more preferably 0.1 to 5 parts by weight, based on 100 parts by weight of the acrylic copolymer. When the amount of the cross-linking agent is less than 0.1 wt %, the cohesive strength can be decreased due to insufficient cross-linking, thereby resulting in durability deterioration such as lifting and damaging cutting property. When the amount of the cross-linking agent is more than 15 wt %, the residual stress cannot be sufficiently relaxed due to excessive cross-linking.

The silane coupling agent is used to enhance adhesion, thereby preventing bubbles, lifting, or peeling, and improving durability under high heat and moisture condition. One embodiment of the present invention is characterized by comprising a silane coupling agent having a solubility parameter of 10.2 to 13.0 (Cal/cm³)^{0.5}.

In one embodiment of the present invention, the silane coupling agent comprises a silane compound of formula (1):

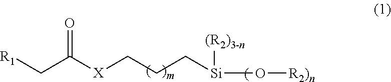

wherein,

R₁ is phenyl substituted or unsubstituted with one or more substituents selected from the group consisting of hydrogen, C₁₋₆ alkyl, nitro, cyano, acyl, alkoxycarbonyl and sulfonyl; nitro; COR₃; or SO₂R₄;

X is NH, O or S, provided that if R₁ is COR₃, X is NH or S;

m is an integer of 0 to 4;

n is an integer of 1 to 3;

R₂ is C₁₋₆ alkyl; and

R₃ and R₄ are each independently C₁₋₆ alkyl or aryl.

The term “C₁₋₆ alkyl” as used herein means a straight or branched hydrocarbon having 1 to 6 carbon atoms, which includes methyl, ethyl, n-propyl, i-propyl, n-butyl, n-pentyl, n-hexyl, etc., but is not limited thereto.

The term “aryl” as used herein includes all of aromatic group, heteroaromatic group and partially reduced derivatives thereof. The aromatic group means a 5 to 15-membered simple or fused ring. The heteroaromatic group means an aromatic group containing at least one atom selected from oxygen, sulfur and nitrogen. Examples of the aryl include phenyl, naphthyl, pyridinyl, furanyl, thiophenyl, indolyl, quinolinyl, imidazolinyl, oxazolyl, thiazolyl, tetrahydronaphthyl, etc., but are not limited thereto.

The silane coupling agent of the present invention may comprise at least one selected from silane compounds of formula (2) to (6):

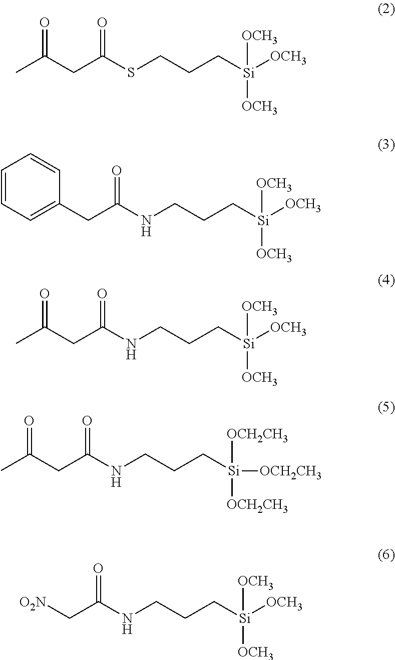 [SMILES: CO[Si](CCCSC(=O)CC(C)=O)(OC)OC ; CO[Si](CCCNC(=O)Cc1ccccc1)(OC)OC ; CO[Si](CCCNC(=O)CC(C)=O)(OC)OC ; CCO[Si](CCCNC(=O)CC(C)=O)(OCC)OCC ; CO[Si](CCCNC(=O)C[N+](=O)[O-])(OC)OC]

The silane compounds of the present invention can be commercially available or easily prepared by conventional methods known in the art. For example, the compound of formula (4) may be easily prepared according to the following Reaction Scheme 1.

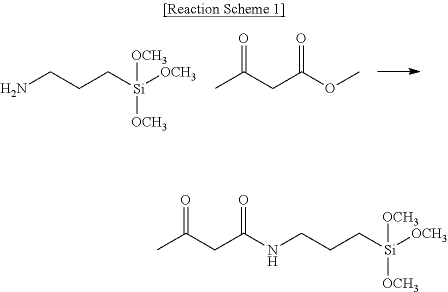

The reagents, the reaction conditions, etc, used in the above Reaction Scheme 1 are apparent to those skilled in the art and may be changed without limitation.

The silane coupling agent may be preferably contained in an amount of 0.01 to 5 parts by weight, more preferably 0.05 to 2.5 parts by weight, based on 100 parts by weight of the acrylic copolymer. When the amount of the silane coupling agent is less than 0.01 wt %, the adhesion with a substrate under high heat and moisture condition can be lowered. When the amount of the silane coupling agent is more than 5 wt %, bubbles or peeling can occur, thereby deteriorating durability.

The adhesive composition according to one embodiment of the present invention, if necessary, may further comprise an additive such as an adhesion enhancing resin, an antioxidant, an anti-corrosive agent, a leveling agent, a surface lubricant, a dye, a pigment, a defoaming agent, a filler, a light stabilizer, and an antistatic agent in order to control adhesion, cohesion, viscosity, elasticity, glass transition temperature, antistatic property, etc.

The adhesive composition of the present invention may be used for an adhesive for attaching a polarizing plate with a liquid crystal cell and an adhesive for a surface protective film. Also, the adhesive composition may be used for an adhesive for a protective film, a reflective sheet, an adhesive sheet for structures, an adhesive sheet for photographs, an adhesive sheet for traffic lanes, optical adhesive products, an adhesive for electronic parts, general adhesive sheet products, and medical patches.

One embodiment of the present invention relates to a polarizing plate including an adhesive layer comprising the adhesive composition as described above.

The thickness of the adhesive layer may vary depending on its adhesive strength, and may preferably range from 3 to 100 μm, more preferably 10 to 100 μm.

Such a polarizing plate may be applied to typical liquid crystal display devices. Particularly, the polarizing plate may be used to fabricate a liquid crystal display device including a liquid crystal panel wherein the polarizing plate having the adhesive layer is laminated on at least one side of a liquid crystal cell.

Therefore, one embodiment of the present invention relates to a liquid crystal display device having the polarizing plate on at least one side of a liquid crystal cell.

The present invention is further illustrated by the following examples, comparative examples and experimental examples, which are not to be construed to limit the scope of the invention.

### PREPARATION EXAMPLE 1

### Preparation of Acrylic Copolymer

To a 1L reactor equipped with a cooler and subjected to nitrogen gas flow were added a monomer mixture consisting of 85 parts by weight of n-butyl acrylate (BA), 7 parts by weight of methyl acrylate (MA), 5 parts by weight of 2-hydroxyethyl acrylate, and 3 parts by weight of acrylic acid, and then 100 parts by weight of ethyl acetate (EAc) as a solvent. Then, nitrogen gas was purged for 1 hour to remove oxygen, followed by maintaining the temperature to 62° C. After uniformly stirring the mixture, 0.07 parts by weight of azobisisobutyronitrile (AIBN) as a reaction initiator was added thereto, and the resulting mixture was reacted for 8 hours to give an acrylic copolymer (weight average molecular weight: about 1,000,000).

### EXAMPLES 1 TO 5

### Preparation of Adhesive-Coated Polarizing Plate

(1) Preparation of Adhesive Composition

100 parts by weight of the acrylic copolymer prepared in Preparation Example 1, 0.4 parts by weight of the silane compound listed in Table 1, and 1.0 parts by weight of isocyanate cross-linking agent (COR-L, Nippon Polyurethane Industry) were mixed, and diluted to a concentration of 28 wt % in consideration of coating properties to give an adhesive composition.

(2) Preparation of Adhesive-Coated Polarizing Plate

The adhesive composition prepared as above was applied on a silicon releasing agent-coated film so that the thickness is 25 μm after hardening, and dried at 100° C. for 1 minute, 5 minutes and 10 minutes to form an adhesive layer. Another release film was laminated on the formed adhesive layer to give an adhesive sheet.

After peeling the release film from the adhesive sheet, the adhesive layer was attached to an iodine polarizing plate with a thickness of 185μm to prepare an adhesive-coated polarizing plate. The resulting polarizing plate was stored at 23° C., 60% RH during aging.

### Comparative Example 1

### Preparation of Adhesive-Coated Polarizing Plate

The same procedures as Example 1 were repeated, except that the silane compound listed in Table 1 was used, to give an adhesive-coated polarizing plate.

### Experimental Example 1

### Evaluation of Adhesive Strength and Adhesive Durability

The physical properties of the adhesive-coated polarizing plates prepared in Examples 1 to 5 and Comparative Example 1 were measured using the following methods, and the results were shown in Table 1.

(1) Adhesive Strength

The adhesive-coated polarizing plate was cut into a size of 25 mm×100 mm. After peeling the release film, the adhesive-coated polarizing plate was laminated on a glass substrate (Corning) under a pressure of 0.25 MPa, followed by autoclave treatment at 50° C., 490 pa for 20 minutes to give a sample.

The sample was left at 25 ° C., 50% RH for 24 hours, and its adhesive strength was measured with peeling at a peel rate of 10 m/min and a peel angle of 180° using a universal testing machine (UTM, Instron). The measurement was performed at 25° C., 50% RH.

(2) Adhesive Durability

The adhesive-coated polarizing plate was cut into a size of 90 mm×170 mm. After peeling the release film, the adhesive-coated polarizing plates were laminated on both sides of a glass substrate (110 mm×190 mm×0.7 mm) such that their optical absorption axes were aligned perpendicular to each other. The applied pressure was 5 kg/cm² and a clean room was used to prevent generation of bubbles or impurities.

The heat resistance of the sample was evaluated by observing occurrence of bubbles or peelings after leaving the sample at 80° C. for 1000 hours. Before observing the condition of the sample, the sample was left at room temperature for 24 hours.

In addition, the heat and moisture resistance of the sample was evaluated by observing occurrence of bubbles or peelings after leaving the sample at 60° C., 90% RH for 1000 hours. Before observing the condition of the sample, the sample was left at room temperature for 24 hours.

<Evaluation Criteria>

\textcircled{∘}: no bubble or peeling

◯: less than 5 bubbles or peelings

Δ: at least 5 to less than 10 bubbles or peelings

X: at least 10 bubbles or peelings

TABLE 1

| | | Solubility | Adhesive | Durability | |
|---|---|---|---|---|---|
| | | Parameter | Strength | Heat | Heat/Moisture |
| | Silane Compound | (Cal/cm³)^{0.5} | (N/25 mm) | Resistance | Resistance |
| Example 1 | 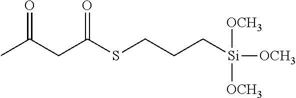 [SMILES: CO[Si](CCCSC(=O)CC(C)=O)(OC)OC] | 10.3 | 8.0 | ◯ | ◯ |
| Example 2 | 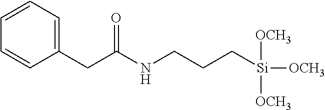 [SMILES: CO[Si](CCCNC(=O)Cc1ccccc1)(OC)OC] | 10.5 | 10.1 | ◯ | ◯ |
| Example 3 | 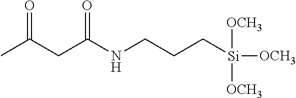 [SMILES: CO[Si](CCCNC(=O)CC(C)=O)(OC)OC] | 10.8 | 11.6 | ⊚ | ◯ |
| Example 4 | 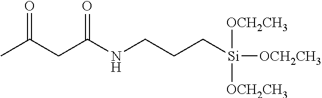 [SMILES: CCO[Si](CCCNC(=O)CC(C)=O)(OCC)OCC] | 10.2 | 6.9 | ◯ | Δ |
| Example 5 | 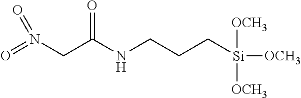 [SMILES: CO[Si](CCCNC(=O)C[N+](=O)[O-])(OC)OC] | 11.4 | 15.0 | ⊚ | ⊚ |
| Com. Example 1 | 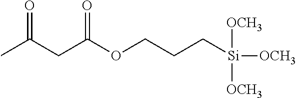 [SMILES: CO[Si](CCCOC(=O)CC(C)=O)(OC)OC] | 10.0 | 2.9 | X | X |

As shown in Table 1, the polarizing plates including the adhesive layers comprising the adhesive compositions of Examples 1 to 5 comprising the silane compounds according to the present invention showed surprisingly higher adhesive strength, heat resistance and heat/moisture resistance, as compared with that of Comparative Example 1 comprising the silane compound having f3 -ketoester and alkoxy groups.

Although particular embodiments of the present invention have been shown and described, it will be understood by those skilled in the art that it is not intended to limit the present invention to the preferred embodiments, and it will be obvious to those skilled in the art that various changes and modifications may be made without departing from the spirit and scope of the invention.

The scope of the present invention, therefore, is to be defined by the appended claims and equivalents thereof.

1. An adhesive composition comprising a silane coupling agent having a solubility parameter of 10.2 to 13.0 (Cal/cm³)^{0.5}.

2. The adhesive composition of claim 1, wherein the adhesive composition comprises an acrylic copolymer, a cross-linking agent, and a silane coupling agent having a solubility parameter of 10.2 to 13.0 (Cal/cm³)^{0.5}.

3. The adhesive composition of claim 1, wherein the silane coupling agent comprises a silane compound of formula (1): 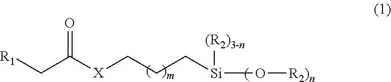
wherein,
R₁ is phenyl substituted or unsubstituted with one or more substituents selected from the group consisting of hydrogen, C₁₋₆ alkyl, nitro, cyano, acyl, alkoxycarbonyl and sulfonyl; nitro; COR₃; or SO₂R₄;
X is NH, O or S, provided that if R₁ is COR₃, X is NH or S;
m is an integer of 0 to 4;
n is an integer of 1 to 3;
R₂ is C₁₋₆ alkyl; and
R₃ and R₄ are each independently C₁₋₆ alkyl or aryl.

4. The adhesive composition of claim 1, wherein the silane coupling agent comprises at least one selected from silane compounds of formula (2) to (6):

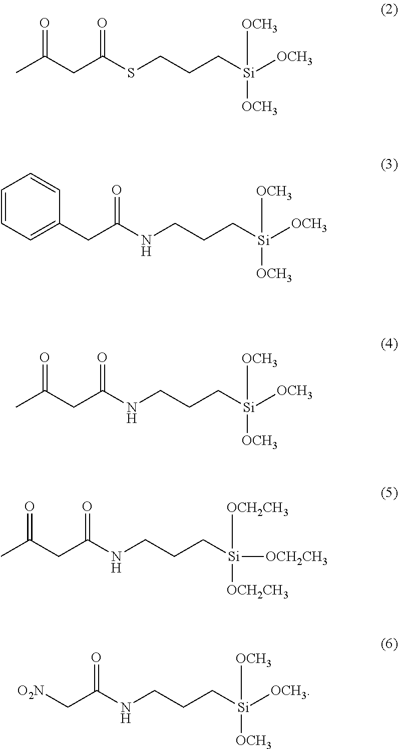 [SMILES: CO[Si](CCCSC(=O)CC(C)=O)(OC)OC ; CO[Si](CCCNC(=O)Cc1ccccc1)(OC)OC ; CO[Si](CCCNC(=O)CC(C)=O)(OC)OC ; CCO[Si](CCCNC(=O)CC(C)=O)(OCC)OCC ; CO[Si](CCCNC(=O)C[N+](=O)[O-])(OC)OC]

5. The adhesive composition of claim 2, wherein the silane coupling agent is contained in an amount of 0.01 to 5 parts by weight based on 100 parts by weight of the acrylic copolymer.

6. A polarizing plate including an adhesive layer comprising the adhesive composition of claim 1.

7. A liquid crystal display device having a polarizing plate on at least one side of a liquid crystal cell, wherein the polarizing plate comprises an adhesive layer, said adhesive layer comprising an adhesive composition comprising a silane coupling agent having a solubility parameter of 10.2 to 13.0 (Cal/cm³)^{0.5}.

8. A polarizing plate including an adhesive layer comprising the adhesive composition of claim 2.

9. A polarizing plate including an adhesive layer comprising the adhesive composition of claim 3.

10. A polarizing plate including an adhesive layer comprising the adhesive composition of claim 4.

11. A polarizing plate including an adhesive layer comprising the adhesive composition of claim 5.

12. The liquid crystal display device of claim 7, wherein the adhesive composition comprises an acrylic copolymer, a cross-linking agent, and a silane coupling agent having a solubility parameter of 10.2 to 13.0 (Cal/cm³)^{0.5}.

13. The Aliquid crystal display device of claim 7, wherein the silane coupling agent comprises a silane compound of formula (1): 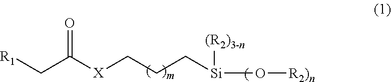
wherein,
R₁ is phenyl substituted or unsubstituted with one or more substituents selected from the group consisting of hydrogen, C₁₋₆ alkyl, nitro, cyano, acyl, alkoxycarbonyl and sulfonyl; nitro; COR₃; or SO₂R₄;
X is NH, O or S, provided that if R₁ is COR₃, X is NH or S;
m is an integer of 0 to 4;
n is an integer of 1 to 3;
R₂ is C₁₋₆ alkyl; and
R₃ and R₄ are each independently C₁₋₆ alkyl or aryl.

14. The liquid crystal display device of claim 7, wherein the silane coupling agent comprises at least one selected from silane compounds of formula (2) to (6):

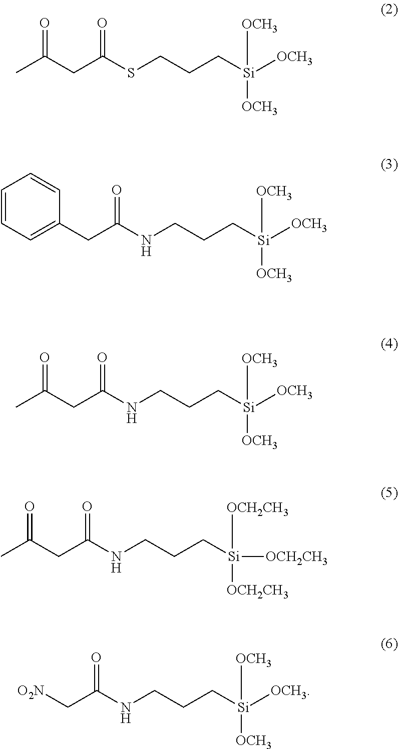 [SMILES: CO[Si](CCCSC(=O)CC(C)=O)(OC)OC ; CO[Si](CCCNC(=O)Cc1ccccc1)(OC)OC ; CO[Si](CCCNC(=O)CC(C)=O)(OC)OC ; CCO[Si](CCCNC(=O)CC(C)=O)(OCC)OCC ; CO[Si](CCCNC(=O)C[N+](=O)[O-])(OC)OC]

15. The A liquid crystal display device of claim 12, wherein the silane coupling agent is contained in an amount of 0.01 to 5 parts by weight based on 100 parts by weight of the acrylic copolymer.
